(19) United States
(12) Patent Application Publication
(10) Pub. No.: US 2002/0023263 A1
(43) Pub. Date: Feb. 21, 2002

(54) Advertising system using E-coupon data broadcasting and method therefor

(76) Inventors: Jun-Ho Ahn, Seoul (KR); Chang-Kl Lee, Seoul (KR); Hee-Jung Kim, Seoul (KR)

Correspondence Address: ROBERT E. BUSHNELL, 1522 K STREET NW, SUITE 300, WASHINGTON, DC, 200051202

(21) Appl. No.: 09/791,385

(22) Filed: Feb. 23, 2001

(30) Foreign Application Priority Data
Aug. 18, 2000 (KR) 00-47808

(51) Int. Cl. H04N 7/173

(52) U.S. Cl. 725/32; 725/23; 725/131; 725/1

(57) ABSTRACT

An advertising system uses a broadcast station to transmit a data advertising broadcast including E-coupon information. The broadcasted E-coupon is used as a medium, and an advertiser, TV viewers and shops are connected in a network by a payment company so that active participation in the advertisement by the TV viewers can be promoted. Statistical data relating to the advertised E-coupon is provided to the advertiser so that the effect of advertisement can be determined and improved. According to the invention using the above-described E-coupon data broadcast, the advertiser, the shop and the viewers are linked in a network centering around a payment company server. Viewer participation in the advertising broadcast is promoted, and the advertiser is able to objectively calculate or determine the audience rating and advertising effect. In addition, some of advertising revenue is distributed to the participants in the network so that the effect of the advertising can be maximized.

### CLAIM OF PRIORITY

This application makes reference to, incorporates the same herein, and claims all benefits accruing under 35 U.S.C. § 119 from my application SYSTEM AND METHOD FOR PROVIDING AN ADVERTISING SERVICE USING E-COUPON DATA BROADCASTING filed with the Korean Industrial Property Office on Aug. 18, 2000 and there duly assigned Serial No. 47808/2000.

### BACKGROUND OF TH INVENTION

1. Technical Field

The present invention relates to an advertising system using a television and a method therefor and, more particularly, to an advertising system using E-coupon data broadcasting and a method therefor in which, using a data broadcast, a broadcasting station transmits a data advertising broadcast including E-coupon information. Using the broadcasted E-coupon as a medium, an advertiser, the TV viewers, and shops are connected in a network by a payment company so that active participation by TV viewers in the advertisement can be promoted. Statistical data on the advertised E-coupon is provided to the advertiser so that the effect of advertisement can be estimated.

2. Related Art

In conventional TV advertising, after an advertiser makes an advertisement contract with a broadcasting station, a broadcast advertising a company or product is produced, and then the broadcast is transmitted by the broadcasting station. Then, the TV viewers passively watch the advertising broadcast between TV programs.

However, in the conventional technology relating to advertising broadcasts, there has not been provided an advertising system and method in which the viewers can actively participate in the advertising broadcast and gain profits by doing so. Thus, there has been a limit to the extent to which the effect of advertisement can be increased. Also, advertisers have not been able to objectively calculate the audience rating and the effect of advertisement.

### SUMMARY OF THE INVENTION

To solve the above problems, it is an object of the present invention to provide an advertising system and method using E-coupon data broadcasting, in which an advertising broadcast including E-coupon information is transmitted. In accordance with the invention, TV viewers are provided with the chance of receiving an E-coupon, a type of discount coupon, by participating in the advertising broadcast. Furthermore, a payment company connects the advertiser, shops and the TV viewers who are participating in the advertising broadcast in one network, and distributes advertising profits generated through the E-coupon data broadcasting advertisement to the participants of the advertisement, thereby increasing the effect of advertisement.

To accomplish the above object of the present invention, there is provided an advertising system using an E-coupon data broadcast. The advertising system has a shop computer for transmitting data relating to an E-coupon presented by a buyer to a payment company server through a network. A payment company server executes a process in which data relating to the E-coupon transmitted from the shop computer is analyzed; a statistical calculation of the corresponding E-coupon is performed, and the result is stored in a database; advertisement statistics on the E-coupon information accumulated in the database are transmitted to an advertiser computer; based on the advertisement statistics information, an advertising fee including a discount amount is calculated, and the advertising fee is paid by the advertiser; and the discount amount is paid to the shopkeeper.

To accomplish another object of the present invention, there is also provided an advertising method using an E-coupon data broadcast, wherein a method for operating a payment company server of an advertising system using an E-coupon data broadcast includes the steps of: (a) receiving data relating to the E-coupon presented by a buyer from an E-coupon supporting shop through a network; (b) analyzing data relating to the E-coupon data input in step (a), performing a predetermined statistical calculation, and then storing the result in a database; and (c) editing the E-coupon statistical data stored in the database, and then transmitting the data to the advertiser through the network

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, and wherein:

FIG. 1 is a block diagram used to explain a business model in an advertising system using E-coupon data broadcasting;

FIG. 2 is a block diagram of a broadcast transmitting apparatus of a broadcasting station, the apparatus forming an advertising system using E-coupon data broadcasting according to the present invention;

FIG. 3 is a block diagram of a broadcast receiving apparatus, the apparatus forming an advertising system using E-coupon data broadcasting according to the present invention;

FIG. 4 is a block diagram of a network of the advertising system using E-coupon data broadcasting according to the present invention; and

FIG. 5 is a flowchart of a network operating method which is performed in the server of a payment company of the advertising system using E-coupon data broadcasting according to the present invention.

### DETAILED DESCRIPTION OF THE INVENTION

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to anyone skilled in the art.

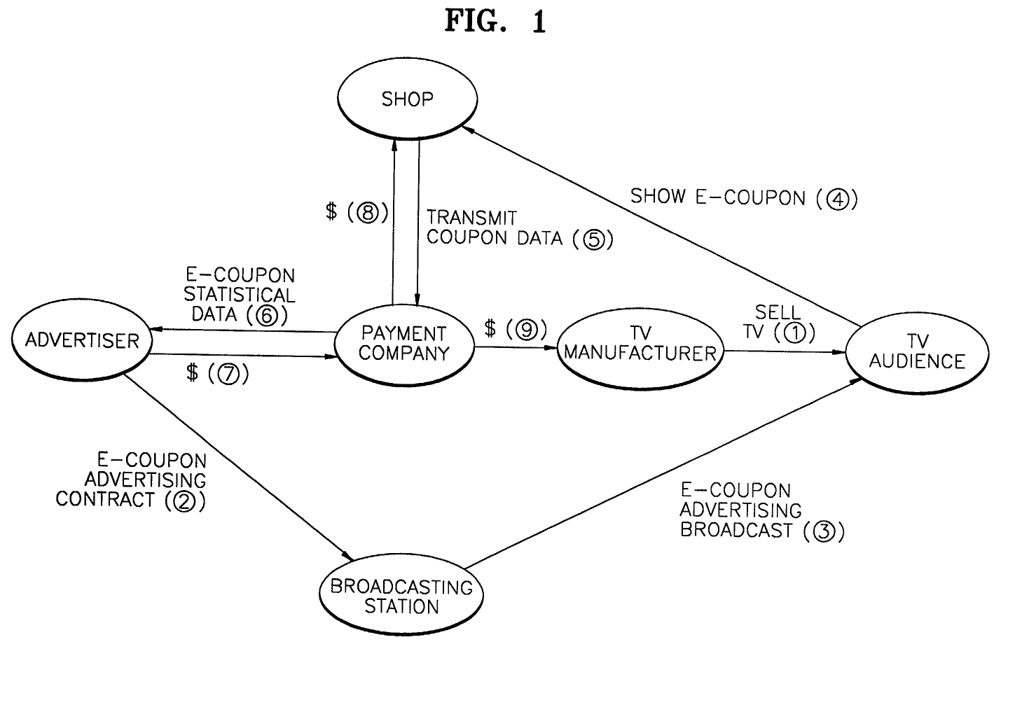

Referring to FIG. 1, the concept of a business model according to the present invention will now be explained.

First, a TV manufacturer manufactures a TV which has an installed smart card for extracting and storing E-coupon data inserted in an advertising broadcast by E-coupon data broadcasting, and the TV is sold to a consumer (a TV viewer) (\mathring{1}). On the smart card, information on the TV manufacturer is also stored so that the TV manufacturer can receive a portion of an advertising fee as compensation from a payment company.

Next, an advertiser makes an E-coupon broadcast advertising contract with a broadcasting station (\mathring{2}). According to the contract, the broadcasting station transmits an E-coupon advertising broadcast which is produced according to the contract (\mathring{3}).

A TV viewer watches the E-coupon advertising broadcast on the TV having the smart card for storing E-coupon information. When watching the E-coupon advertising broadcast, if the viewer wants to receive an E-coupon, the viewer inputs an E-coupon download command using a key input means, such as a remote controller. Then, the E-coupon data included in the received advertising broadcast is stored in the smart card installed in the TV.

The TV viewer then detaches the smart card from the TV. When he buys the corresponding product, the TV viewer can present the E-coupon to a shopkeeper for a discount, or can give an E-coupon information paper, printed through a printer installed in the TV, to the shopkeeper (\mathring{4}).

In the shop, information on the E-coupon which the shopkeeper receives through the smart card or in the form of a printed paper is sent to the server of the payment company (\mathring{5}). The server of the payment company analyzes and statistically calculates the input E-coupon information, and stores the result in a database; then, at a predetermined time interval, the details of an advertising fee, including statistical data of E-coupons and discount amount, are sent to the advertiser (\mathring{6}).

The advertiser then pays the discount amount and advertising fee to the payment company (\mathring{7}), and then the payment company pays a portion of the discount amount and the advertising fee, which the company received from the advertiser, to the shop (\mathring{8}) and to the TV manufacturer (\mathring{9}).

Therefore, the advertiser can objectively calculate the audience rating and advertisement effect of the advertising broadcast, and can encourage TV viewers to actively participate in the advertisement, thereby increasing the effect of the advertisement. Since the viewers can receive discount coupons for products they wish to buy through the TV advertising broadcast, viewers can obtain a financial benefit. The payment company can receive advertising fees from the advertiser, and can manage an advertisement consulting business utilizing the accumulated E-coupon data, and the TV manufacturer can receive payment as well. Therefore, all related parties in the advertising system can reap financial benefits.

Apparatuses required for building an advertising system for the E-coupon data broadcast will now be explained.

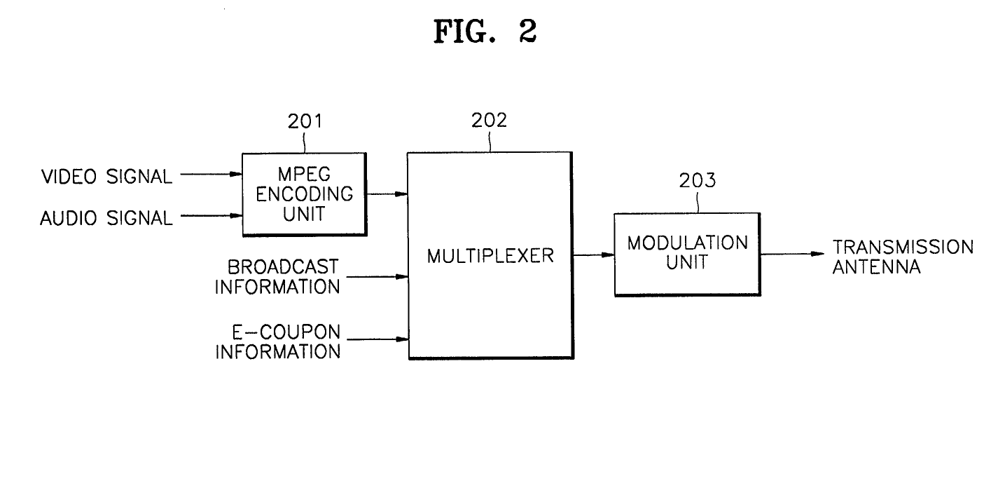

FIG. 2 is a block diagram of a broadcast transmitting apparatus for a broadcasting station, which transmits E-coupon data according to the present invention. The apparatus comprises an MPEG encoding unit 201, a multiplexer 202 and a modulation unit 203.

A video signal and an audio signal to be broadcasted are respectively encoded by the MPEG encoding unit 201.

The multiplexer 202 multiplexes the encoded video and audio data, broadcast information data relating to the broadcasted program information, and E-coupon information data according to the broadcasting standard. Then, the multiplexed data is modulated in the modulating unit 203, and is transmitted as an aerial wave via a transmission antenna.

Using this TV broadcast transmitting apparatus, an advertising broadcast which includes E-coupon data can be transmitted.

A broadcast receiving apparatus for receiving an advertising broadcast including E-coupon data, will now be explained.

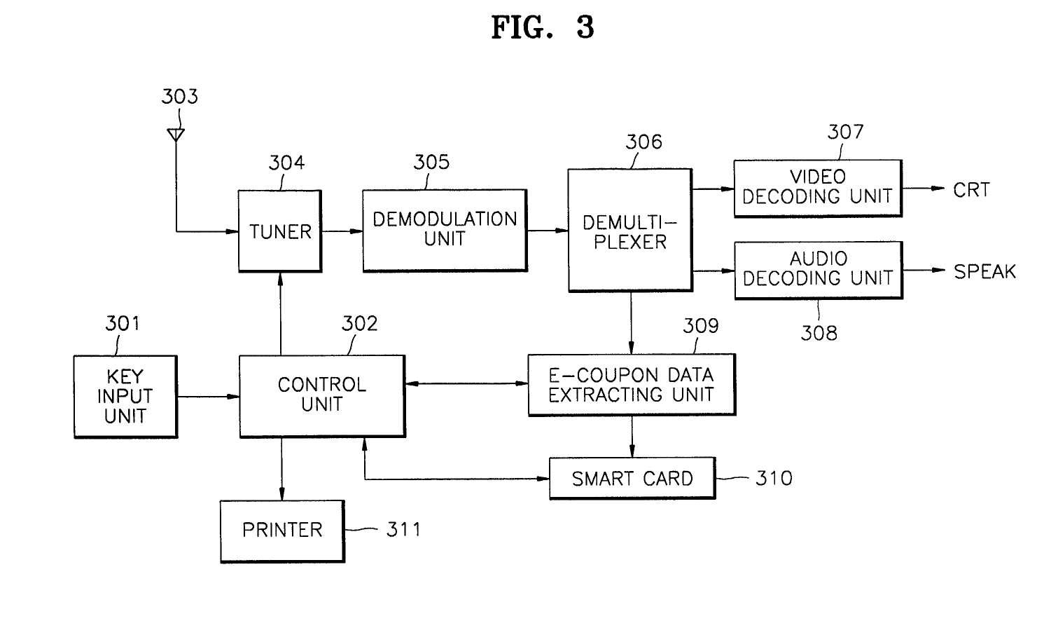

As shown in FIG. 3, the broadcast receiving apparatus is a part of the advertising system using a data broadcast according the present invention, and includes a key input unit 301, a control unit 302, an antenna 303, a tuner 304, a demodulation unit 305, a demultiplexer 306, a video decoding unit 307, an audio decoding unit 308, an E-coupon data extracting unit 309, a smart card 310, and a printer 311.

When a desired channel is selected after the TV power is turned on using a key button of the key input unit 301, the control unit 302 controls the tuner 304 so that a broadcast signal of a channel, selected by a user from among the broadcasting signals received via the antenna 303, is tuned and provided as an output. Then, the selected and tuned broadcast signal is demodulated in the demodulation unit 305. The demodulated output is then divided into individual bit streams of video, audio and additional information via the demultiplexer 306, and the individual bit streams are then output to the video decoding unit 307, the audio decoding unit 308 and the E-coupon data extracting unit 309, respectively.

The video decoding unit 307 and the audio decoding unit 308 decode the divided video bit stream and audio bit stream, respectively, and output the decoded results via a Braun tube (CRT) and a speaker, respectively.

The E-coupon data extracting unit 309 extracts only E-coupon data included in the received additional information, and then outputs the extracted data to the smart card 310.

When the TV viewer wishes to receive an E-coupon when watching the E-coupon data advertising broadcast, he inputs an E-coupon download command using the key input unit 301. Then, according to a control command from the control unit 302, the E-coupon data output from the E-coupon data extracting unit 309 is stored in the smart card 310.

The E-coupon information stored in the smart card 310 can be printed on paper, using the printer 311. Moreover, the smart card 310 can be designed to be detachable. In this case, when the viewer shows the smart card 310 storing the E-coupon data to a shopkeeper, the E-coupon can be read in a smart card reader kept in the shop.

Next, a method for operating the advertising system using the E-coupon data broadcast through the Internet will be explained.

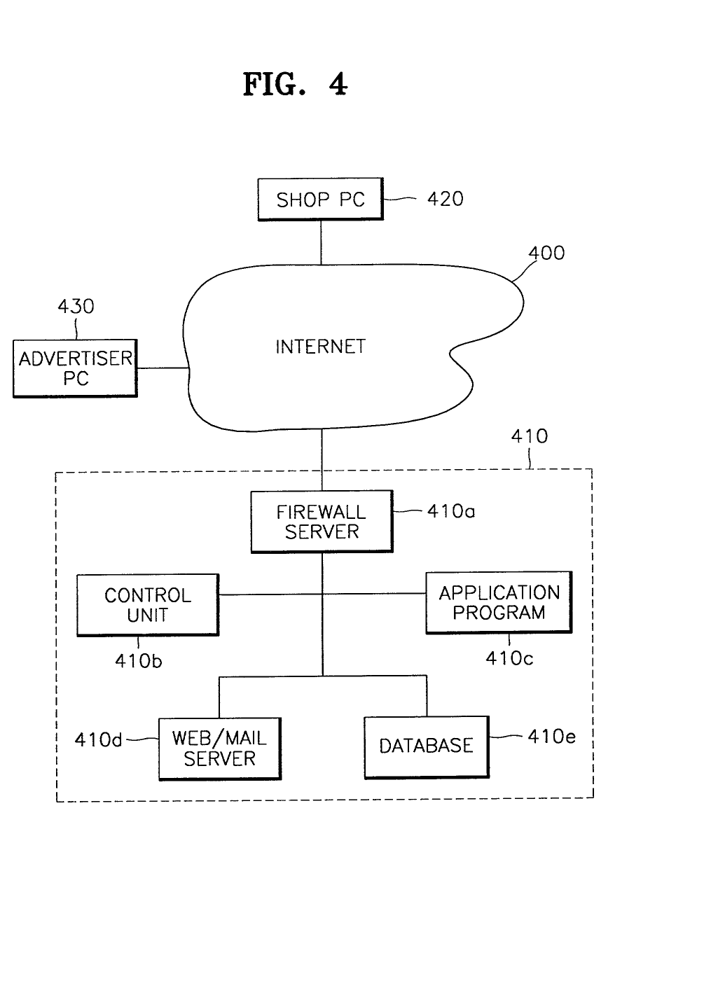

As shown in FIG. 4, the advertising system using the E-coupon data broadcast connected through the Internet includes the Internet 400, a payment company server 410, a shop computer or personal computer (PC) 420, and an advertiser computer or PC 430.

The Internet 400 is a communication network globally linking computers through a web. In order for the users of the shop computer 420 and advertiser computer 430 to receive the Internet services, they must be assigned Internet protocol (IP) addresses, using Internet link software such as a point-to-point protocol (PPP). Then, using the addresses, they can receive the Internet services through world wide web (WWW) browsers. In order to receive the WWW service, the users access the server of a desired web site using a web browser, such as Netscape Navigator or Microsoft Internet Explorer, in order to get desired information. If the shop computer 420 and advertiser computer 430 are connected to the communication network through a dedicated line instead of a modem, the shop computer 420 and advertiser computer 430 are linked to the Internet using TCP/IP protocol instead of the PPP.

In this way, the shop computer 420 and the advertiser computer 430 are linked through the Internet 400 to the payment company server 410, which is one among many web site servers.

The payment company server 410 further includes a firewall server 410a, a control unit 410b, an application program 410c, a web/mail server 410d and a database 410e.

The operations of the elements forming the payment company server 410 will now be explained.

The firewall server 410a has hardware and software for protecting the information contained within the payment company server and for preventing an inflow of harmful information from the outside when information is exchanged through the Internet. For example, an illegal outflow of inside information is prevented by a program for limiting external access, using an IP address, a user authentication number, a port number, etc.

The control unit 410b controls the system as a whole, including the management of the database 410e. Also, the control unit 410b connects the advertiser and E-coupon using shops through one network, the Internet 400; provides E-coupon advertisement service information requested through the Internet; analyzes E-coupon data input from the shop computer 420; updates E-coupon statistical data stored in the database 410e by performing statistical calculation of corresponding E-coupons; and executes a process for paying the advertising fee, including discount amount, according to the rules of a contract.

The application programs 410c are for executing various processes, including management of the database 410e, related to the E-coupon advertising service provided by the payment company server 410, and are stored in a memory (not shown).

When the shop computer 420 or the advertiser computer 430 accesses the payment company server 410 through the Internet 400, the web/mail server 410d sends menu screen information for selecting and executing various processes provided in the present invention; operates an application program 410c corresponding to the selected menu and input data on the menu screen information; and sends information as to the result of executing the corresponding process to the shop computer 420 or the advertiser computer 430 using a transmission program commonly used in the Internet 400. Particularly, the web/mail server 410d sends summarized E-coupon statistical data and advertising fee calculation information to the E-mail address of the advertiser at a predetermined time according to a transmission standard, and sends information corresponding to any request for various data to the requester's E-mail address.

The database 410e stores information on E-coupons, the advertiser, the shop, the TV manufacturer, diverse E-coupon related statistical data, and advertising fee payment data. That is, the control unit 410b performs analysis and statistical calculation, and updates E-coupon statistical information stored in the database 410e. Information on the TV manufacturer and the user read from the smart card 310 is also stored in the database 410e, together with information on the shop which sent the E-coupon data.

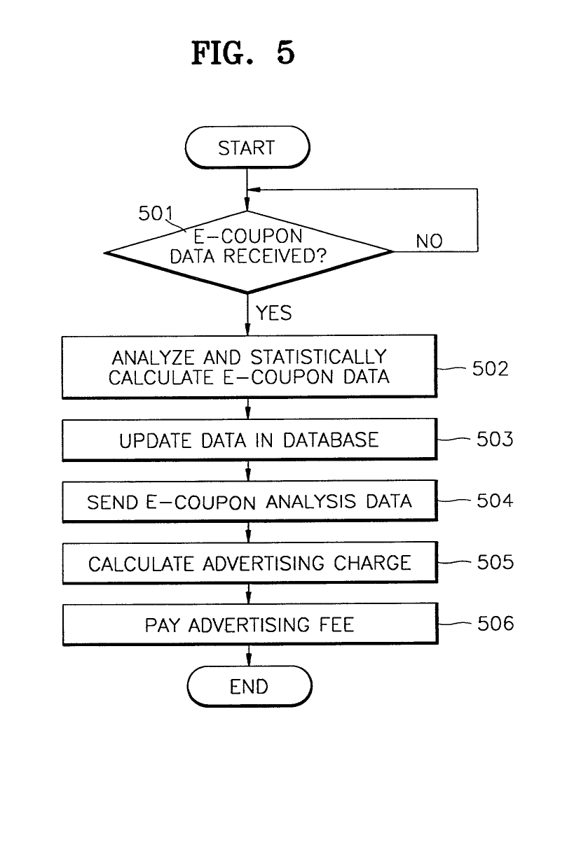

Referring to FIG. 5, an E-coupon advertising service method performed by the payment company server 410 of the present invention will now be explained.

The control unit 410b of the payment company server 410 determines whether or not E-coupon data from the shop computer 420 of the shop which supports the E-coupon is received in step 501. When E-coupon data is received, the received E-coupon data is analyzed and a corresponding statistical calculation is performed in step 502. That is, after dividing the received data into details, including the corresponding product name, information on E-coupon downloading time, manufacturer information relative to the TV through which the E-coupon was downloaded, and other user information, a statistical calculation to obtain the frequency of E coupon use in each item is performed.

Then, in step 503, statistical data stored in the database 410e is updated with the statistically calculated information of the corresponding E-coupon, as analyzed in step 502.

E-coupon analysis data stored in the database 410e is read and edited, and then repeatedly sent to the advertiser computer 430 based on a predetermined time interval (for example, every day, every week, or every month) in step 504. This is to allow the advertiser to independently analyze the audience rating and advertising effect of the advertising broadcast, referring to the return rate of the E-coupon advertisement.

Then, based on the E-coupon statistical data stored in the database 410e, the advertising fee including discounted amount is calculated and sent to the advertiser computer 430 in step 505. Payment of the advertising fee is settled by distributing some of the advertising fee paid by the advertiser to the shopkeeper and the TV manufacturer in step 506.

According to the business model executing an advertisement using the above-described E-coupon data broadcast, the advertiser, the shop and the viewers are linked in a network centered around the payment company server. Also, viewer participation in the advertising broadcast is promoted, the advertiser is enabled to objectively figure out the audience rating and advertising effect, and some of the advertising revenue is accordingly distributed to the participants in the network so that the effect of the advertising can be maximized.

As described above, according to the present invention, using data broadcasting, a data advertising broadcast including E-coupon information is transmitted from a broadcasting station. Taking the broadcasted E-coupon as a medium, the advertiser, the viewers and the shop are connected in a network by the payment company. Then, utilizing E-coupon information, the network is managed so as to generate advertising profits among the participants. By doing so, first, the advertiser can receive advertisement analysis data for objectively measuring the audience rating and advertising effect of the advertising broadcast. Second, since the transmission of bidirectional commercial advertisement increases utilization of advertisements, the broadcasting station benefits from increased advertisement revenue. Third, the viewer can receive an E-coupon (discount coupon) through the TV advertisement. Fourth, the manufacturer of the digital broadcast receiver increases the sales of the TV as a result of stimulated purchasing desire due to the new function of the TV, and the manufacturer can receive some of the advertising fee as compensation. Fifth, with the E-coupon as a medium, the payment company can receive some of the advertising fee to increase its revenue, and can manage an advertisement consulting business utilizing the accumulated E-coupon data.

It should be understood that the present invention is not limited to the particular embodiment disclosed herein as the best mode contemplated for carrying out the present invention, but rather that the present invention is not limited to the specific embodiments described in this specification except as defined in the appended claims.

What is claimed is:

1. An advertising system using an E-coupon data broadcast, the advertising system comprising:
a shop computer for transmitting data relating to an E-coupon presented by a buyer through a network; and
a payment company server connected to the network for receiving the data relating to the E-coupon presented by the buyer, and for executing a process in which the data relating to the E-coupon transmitted from the shop computer is analyzed, a statistical calculation is performed, 8 the result is stored in a database, advertisement statistics information relating to E-coupons accumulated in the database is transmitted to an advertiser computer, an advertising fee including discount amount is calculated based on the advertisement statistics information, the advertising fee is paid by the advertiser, and the discount amount is paid to the shopkeeper.

2. The advertising system of claim 1, wherein the E-coupon is included in a digital advertising broadcast and is then transmitted, and information on the E-coupon is stored in a smart card connected to a digital broadcasting receiver according to a viewer's selection.

3. The advertising system of claim 2, wherein the smart card is detachable from the digital broadcasting receiver.

4. The advertising system of claim 2, wherein the digital broadcasting receiver has an internal printer for printing out information, relating to on E-coupon, stored in the smart card.

5. The advertising system of claim 2, wherein the smart card includes at least one of information as to time for downloading the E-coupon, predetermined user information, and information as to a manufacturer of the digital broadcasting receiver.

6. The advertising system of claim 2, wherein a portion of the advertising fee is paid to a manufacturer of the digital broadcasting receiver as compensation.

7. A payment company server in an advertising system using an E-coupon data broadcast, the payment company server comprising:
a database for storing at least one of information relating to an E-coupon, advertiser information, shop information, TV manufacturer information, statistical information relating to the E-coupon, and advertising fee payment information;
a control unit for controlling the system, including management of the database, for providing information relating to and processing an E-coupon advertising service after connecting an advertiser and E-coupon supporting shops in a network, for executing a process for analysis and statistical calculation of E-coupon data input through the network, and for executing a process for advertising fee payment according to a predetermined rule; and
a web/mail server for transmitting an execution result of a process relating to the E-coupon advertising service processed in the control unit to a user computer according to a transmission protocol commonly used in the network in response to a request from the user computer connected through the network, and for transmitting the execution result of the process relating to the E-coupon advertising service to a designated address within a predetermined time.

8. A broadcast receiving apparatus using an E-coupon data broadcast, comprising:
a tuner for tuning a digital broadcast signal of a channel selected by a user from among a plurality of digital broadcast signals received via an antenna, and for providing a tuner output;
a demodulation unit for demodulating the tuner output from the tuner to produce a demodulated digital broadcast data output;
a demultiplexer for demultiplexing the demodulated digital broadcast data output from the demodulation unit so as to separately output video data, audio data and additional information data;
an E-coupon data extracting unit for receiving the additional information data from the demultiplexer, and for separately extracting E-coupon data;
a control unit for analyzing input key data, and responsive to the input key data comprising a key command for storing the E-coupon data, and for generating a command for downloading the E-coupon; and
a smart card for storing the E-coupon data extracted by the E-coupon data extracting unit when the command for downloading the E-coupon is generated.

9. The broadcast receiving apparatus of claim 8, further comprising a smart card which stores E-coupon data and which is detachable from the E-coupon data broadcast receiving apparatus.

10. The broadcast receiving apparatus of claim 9, further comprising:
a printer for making a hard copy of the E-coupon data stored in the smart card.

11. The broadcast receiving apparatus of claim 9, wherein the smart card also stores information on time for downloading the E-coupon data.

12. The broadcast receiving apparatus of claim 9, wherein the smart card is designed so that user information can be registered according to a user's selection.

13. The broadcast receiving apparatus of claim 9, wherein
the smart card is designed so that information on the manufacturer of the E-coupon data broadcast receiving apparatus can be registered.

14. A method for operating a payment company server of an advertising system using an E-coupon data broadcast, said method comprising the steps of:
(a) receiving data relating to an E-coupon presented by a buyer from an E-coupon supporting shop through a network;
(b) analyzing the data relating to the E-coupon received in step (a), performing a predetermined statistical calculation to obtain a result, and then storing the result in a database; and
(c) editing the result stored in the database to obtain edited data, and then transmitting the edited data to an advertiser through the network.

15. The method of claim 14, wherein the E-coupon comprises a discount coupon which the buyer downloads from an advertising broadcast which is transmitted from a broadcast station and which includes E-coupon information, said buyer using a smart card installed in an E-coupon data broadcast receiving apparatus.

16. The method of claim 14, wherein the E-coupon comprises a discount coupon, and wherein the buyer uses a smart card installed in an E-coupon data broadcast receiving apparatus to download the discount coupon selectively from an advertising broadcast which is transmitted from a broadcast station and which includes E-coupon information, and then outputs the discount coupon via a printer.

17. The method of claim 14, said method further comprising the steps of:
calculating an advertising fee including a discount amount based on E-coupon statistical data stored in the database, receiving the advertising fee from an advertiser, and then paying the received discount amount to the E-coupon supporting shop.

18. A shop computer operating method for use in an advertising system using an E-coupon data broadcast, said method comprising the steps of:
(a) reading information on an E-coupon presented by a buyer;
(b) transmitting the information read in step (a) to a payment company server; and
(c) receiving a discount amount paid by the payment company server as a result of step (b).
